(19) United States
(12) Patent Application Publication
(10) Pub. No.: US 2024/0211678 A1
(43) Pub. Date: Jun. 27, 2024

(54) ENCODING DOCUMENTS FOR PERIPHERAL PRIVACY

(71) Applicant: Microsoft Technology Licensing, LLC, Redmond, WA (US)

(72) Inventors: Timothy Andrew LARGE, Southwater (GB); Se Hoon LIM, Bellevue, WA (US)

(73) Assignee: Microsoft Technology Licensing, LLC, Redmond, WA (US)

(21) Appl. No.: 18/145,412

(22) Filed: Dec. 22, 2022

(51) Int. Cl. G06F 40/126; G06F 3/01; G06F 21/84

(52) U.S. Cl. CPC G06F 40/126; G06F 3/013; G06F 21/84

(57) ABSTRACT

A computing system for generating and displaying an encoded document for peripheral privacy is provided. The computing system includes a processor executing a program using portions of memory to determine an initial document, generate an encoded document based on the initial document by modifying letters in a text portion of the initial document, and output the encoded document. In another example, a computing system for displaying an encoded document for peripheral privacy is provided. The computing system includes a processor executing a program using portions of memory to receive an initial document and an encoded document, determine a gaze location of a user using a camera, generate a mask based on the determined gaze location, and display an alpha-blended document by alpha-blending the initial document and the encoded document using the mask.

### BACKGROUND

Privacy concerns for public computer use include a wide number of issues. Keeping information secured digitally can be achieved through sophisticated software and data encryption practices, but such methods lack protection of sensitive information against wandering eyes while using a computer screen in public. Although simple in nature, prying eyes from onlookers can be a serious security threat when the computer screen is displaying confidential and sensitive information. These threats are visual in nature and are difficult to avoid. Even outside of work-related purposes, sensitive information is often on display during computer use for the average user. For example, a person making an online bill payment, filling out forms, or simply writing an email may inadvertently expose personal information to possible identity theft.

### SUMMARY

In one example, a computing system for generating an encoded document for peripheral privacy is provided. The computing system comprises a processor and memory, the processor executing a program using portions of the memory to determine an initial document, generate an encoded document based on the initial document by modifying letters in a text portion of the initial document, and output the encoded document.

In another example, a computing system for displaying an encoded document for peripheral privacy is provided. The computing system includes a processor executing a program using portions of memory to receive an initial document and an encoded document, determine a gaze location of a user using a camera, generate a mask based on the determined gaze location, and display an alpha-blended document by alpha-blending the initial document and the encoded document using the mask.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of an example computing system for generating an encoded document for privacy applications.

FIG. 2 shows a schematic view of an example computing system for displaying an encoded document.

FIGS. 3A and 3B show tables of an example character encoding scheme based on topological similarity.

FIG. 4 shows an example privacy view mode of an encoded text document.

FIGS. 5A-5E show graphs illustrating an example saccade model and the effects of applying saccade prediction methods.

FIG. 6 schematically illustrates a flow diagram of an example method for generating an encoded document for peripheral privacy.

FIG. 7 schematically illustrates a flow diagram of an example method for displaying an encoded document for peripheral privacy.

FIG. 8 schematically shows a non-limiting embodiment of a computing system.

### DETAILED DESCRIPTION

Information security threats from the visual exposure of computer screens during public use is a risk in many settings. Current solutions include various methods of restricting viewing conditions such that light from the display reaches the intended user's eyes while preventing light from reaching bystanders. Some solutions include the application of a physical privacy screen or filter designed to prevent onlookers from viewing the computer display at certain angles. The privacy screen is typically a thin layer of plastic placed over the computer display. The plastic can be designed with various optical properties to restrict viewing conditions. For example, the privacy screen may employ the polarization properties of light to prevent light from passing through at certain angles. Another example includes a privacy screen that uses a microscopic version of a window louver, which can be referred to as louver filters or “Venetian blind” structures. Both solutions can provide for a computer display that is unreadable to onlookers at oblique angles. Although simple to implement and install, a privacy screen is a physical layer that makes the computer display appear duller, even to the intended user's eyes, as 100% light efficiency is difficult to achieve.

Another class of solutions include software implementations that use webcams and real-time eye tracking to dim or blur areas in which the user's gaze is not fixated. Such implementations form a “spotlight” in the area on which the user's eyes are fixated. However, indiscriminately dimming or blurring non-fixated areas makes reading text more difficult for the average user. The user experience is similar to viewing the computer screen through a telescope as the edges of the blurred and non-blurred areas are highly visible to the user. For a typical reader, the brain uses periphery information during the reading process to anticipate sentence and paragraph structure to upkeep a natural reading speed. Removing such information creates an uncomfortable and less efficient reading experience. Another issue occurs when the software updates to blur and unblur areas in accordance to changes in the user's gaze. Changes in the mask edges, especially clear and defined edges, create a distracting flickering effect for the reader.

In view of the observations above, examples are disclosed that provide for private computing device viewing modes using encoded documents and gaze tracking and prediction. An encoded document can be generated from an initial document by encoding and replacing text and/or graphics in the initial document. During display of the document, a privacy view mode can be implemented to render and display an alpha-blended (transparency-blended) version of the encoded and initial documents. The encoded and initial documents can be alpha-blended using a mask in which the encoded version of the document is shown in the peripheral regions of the user's view and the initial document is shown at the location of the user's fixation point (foveal region). The mask values for applying the alpha-blend can be determined by where the user's vision is fixated on the computer screen at a given time point. An eye tracker can be used to determine the user's gaze location on the screen. The mask values in the foveal region are such that text and graphics from the initial document in the foveal region is displayed. The mask values in a peripheral region outside the foveal region are set to display the text and graphics of the encoded document.

In some implementations, the mask values are non-binary, and a gradient transition can be applied from the foveal region to the peripheral region. For example, the mask can be implemented with a clear center area (such that the initial document is displayed) surrounded by a graded area where the alpha value goes from 1 to 0 (or 0 to 1, depending on the application). In this area, the initial document blends smoothly into the encoded document, and the “telescope” effect described above can be reduced or eliminated. Furthermore, the peripheral flickering effect found in solutions that implement dimming or blurring can also be reduced or eliminated. The gradient can be applied linearly or in accordance with any other function. In some implementations, the encoded document and the initial documents are stored on the computing device on which the document is being displayed. For example, the encoded and initial documents can be stored in the memory of a graphics processing unit (GPU) of the computing device. By storing these pre-calculated images in memory, the variable blending and masking operations can be much faster in terms of speed and computing cost compared to remote storage. As such, the system latency is reduced in comparison to previous methods of actively blurring or dimming the document in real-time.

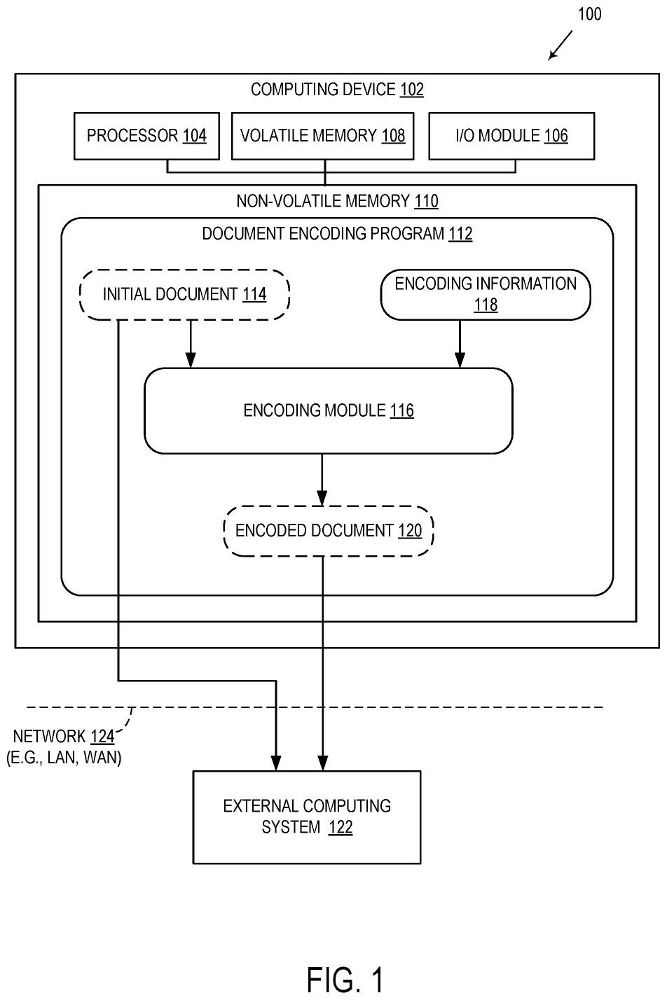

FIG. 1 shows a schematic view of an example computing system 100 for generating an encoded document for privacy applications. The computing system 100 includes a computing device 102. The computing device includes a processor 104 (e.g., central processing units, or “CPUs”), an input/output (I/O) module 106, volatile memory 108, and non-volatile memory 110. The different components are operatively coupled to one another. The non-volatile memory 110 stores a document encoding program 112, which contains instructions for the various software modules described herein for execution by the processor 104.

Upon execution by the processor 104, the instructions stored in the document encoding program 112 cause the processor 104 to initialize the document encoding process, which includes receiving an initial document 114. The document encoding program 112 includes an encoding module 116 that receives the initial document 114 and encoding information 118 describing the encoding scheme in which to encode the initial document 114. The encoding information 118 can be provided in various ways. In the depicted example, the encoding information 118 resides in non-volatile memory 110 of the computing system 100. In other implementations, the encoding information 118 is received from an external system or received from a user.

The encoding module 116 encodes the initial document 114 using the encoding information 118 to generate an encoded document 120. The encoding process can be implemented in various ways. In some implementations, the encoding process includes determining text portions and graphics portions in the initial document 114. To generate the encoded document 120, the text portions can be analyzed and encoded, and the graphics portions can be blurred or camouflaged with images generated using style transfer techniques.

The initial document 114 and the encoded document 120 can then be transmitted for use in display applications. In the depicted example, the initial document 114 and the encoded document 120 are transmitted to an external computing system 122 via network 124. In other implementations, the initial document 114 and the encoded document 120 are used by the local computing system 100 for use in a display application.

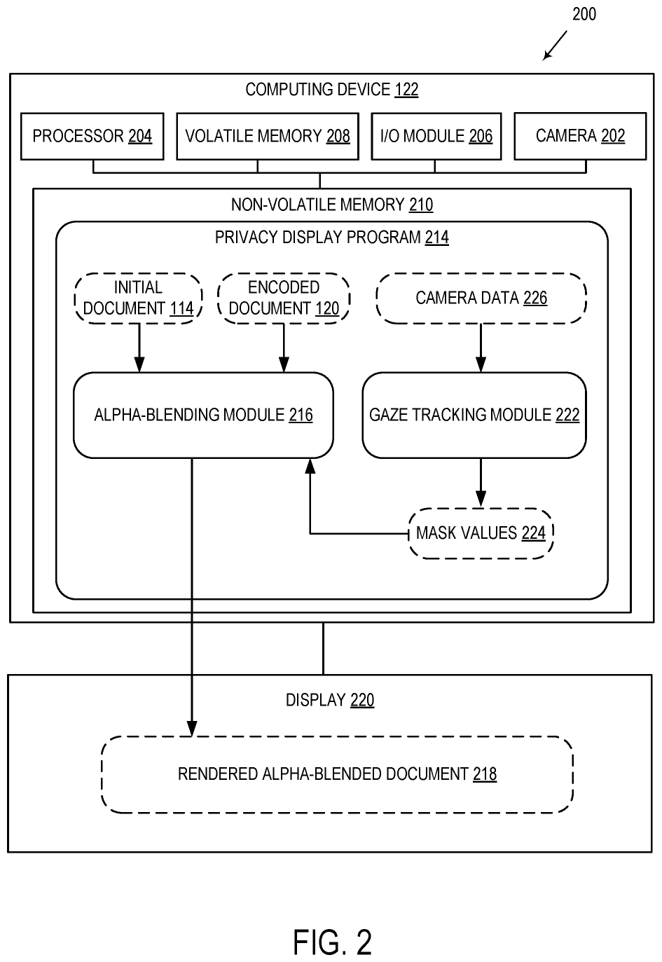

FIG. 2 shows a schematic view of an example computing system 200 for displaying an encoded document 120. The computing system 200 includes a computing device 122 that further includes a camera 202, a processor 204, an input/output (I/O) module 206, volatile memory 208, and non-volatile memory 210. The different components are operatively coupled to one another. The non-volatile memory 210 stores a privacy display program 214, which contains instructions for the various software modules described herein for execution by the processor 204. The computing device 122 can be implemented as the external computing device to which the encoded document 120 is transmitted, as shown in FIG. 1. As can readily be appreciated, in some implementations, the encoding process described in FIG. 1 and the privacy display process described in FIG. 2 can be performed on the same computing device.

Upon execution by the processor 204, the instructions stored in the privacy display program 214 cause the processor 204 to initialize the display application, which includes retrieving an initial document 114 and an encoded document 120. The initial document 114 and encoded document 120 may be retrieved from local memory 210 or received from an external computing system, such as computing system 100 described in FIG. 1. The privacy display program 214 includes an alpha-blending module 216 that receives the initial document 114 and encoded document 120 and provides information related to the rendering of an alpha-blended document 218 to a display 220. During viewing of the document by a user, the GPU of the system renders and updates the alpha-blended document 218 in real-time in accordance with the information provided by the alpha-blending module 216.

A gaze tracking module 222 is implemented to determine mask values 224 to be applied in the alpha-blending process. The mask values 224 can be implemented as an array or matrix of values describing which document is rendered and displayed in the relative spatial location. For example, in a system where mask values range from 0 to 1, a mask value of 0.5 would present both the encoded and initial document at the related spatial location in equal measure.

The mask values 224 can be determined based on the user's gaze location, which can be determined using the gaze tracking module 222. For example, the position of the center of the mask can be determined by gaze coordinates in real-time, which enables the alpha-blending of the documents in real-time. The gaze tracking module 222 receives camera data 226 from the camera 202 and estimates a gaze location of the user. Camera data 226 can include image data of the user's eyes. Various methods can be implemented to determine the user's gaze location using the camera data 226. In some implementations, one or more light-emitting diodes (LEDs) are implemented, and the user's pupil is detected by analyzing the retroreflection of light emitted from the LEDs off the user's retina. Additionally or alternatively, a machine learning model can be implemented to estimate the user's gaze location. The mask values 224 can be updated in real-time based on the estimated gaze location, and the displayed alpha-blended document can be adjusted accordingly by applying the updated mask values 224 to the blend. Depending on the application, measuring the user's gaze location and applying the mask values 224 to render the alpha-blended document 218 can result in latency in the system that provides an uncomfortable user's reading experience. As such, gaze prediction techniques can be applied to predict the user's next gaze location during a saccadic eye movement, and the mask values 224 can be updated before the user's gaze is settled onto the new location.

The encoding of a document can be performed to promote a natural reading experience. As described above, the human brain relies on sentence and paragraph structure remaining visible in the periphery during the reading process to maintain a natural reading speed. As such, the encoded document shown in the peripheral regions during a privacy view mode can be encoded with an encoding scheme that maintains a similar or approximately similar sentence and paragraph structure. For example, a character encoding scheme can be implemented to replace letters in the initial document with different letters. In such cases, sentence and paragraph length can be maintained while still displaying encoded and unintelligible text in the peripheral regions.

In addition to sentence and paragraph structure, changes in letter geometries in a user's peripheral view can also often be ascertained by the user while reading. To help retain a similar reading experience, the encoding scheme can be implemented to replace letters with other letters of a similar topology. The letters can be replaced with other letters satisfying a topology criterion. The topology criterion can be defined in many different ways. In some implementations, letters satisfying the topology criterion include letters that produces an average luminance within a threshold. For example, letters producing an average luminance within a predetermined range can be categorized together, and letters within a category can be replaced with one another during the encoding process. Such implementations enable encoding schemes that provide unintelligible text in the peripheral regions while still maintaining a similar average luminance in the user's periphery, reducing the chance that the changes between the initial and encoded documents will be noticed by the user. As can readily be appreciated, different encoding schemes can be implemented depending on the application, and certain choices in encoding schemes can involve tradeoffs in security, readability, etc. For example, another topology criterion can include letters having similar heights and widths within a predetermined threshold.

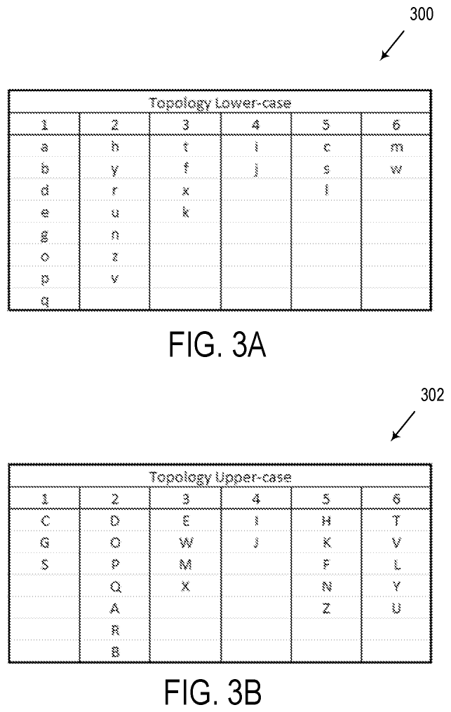

FIGS. 3A and 3B show tables 300, 302 of an example character encoding scheme based on topological similarity. Encoding schemes based on topological similarity can be implemented to reduce visual variation in the encoded document, replacing words with other words of comparable topology and different, or nonsensical, meaning. The tables 300, 302 show an encoding scheme for the English alphabet that includes two separate modulation schemes for lower-case and upper-case letters. Table 300 shows the modulation scheme for lower-case letters, and table 302 shows the modulation scheme for upper-case letters. The lower-case modulation scheme separates the twenty-six lower-case letters of the English alphabet into six different categories based on topological similarities. Similarly, the upper-case modulation scheme also separates the twenty-six upper-case letters of the English alphabet into six different categories based on topological similarities. During the generation of an encoded document, letters in the initial document to be modulated can be switched with a letter of the same category. In the depicted example, the modulation schemes consider both width and height of the letters as criteria for the different categories.

As can readily be appreciated, different modulation schemes with different categories can be used depending on the application. For example, the alphabet can be separated into any number of different categories. Certain letters can be left unmodulated due to having certain unique characteristics. The encoding scheme described in FIGS. 3A and 3B (encoding based on topological similarity) can also be applied to numbers and other alphabets. In some implementations, topological characteristics other than height and width, such as letter curvature and average luminance, are used as the criteria for categorization.

In addition to replacing letters, differences in encoding schemes can also include which letter to modulate. In some implementations, every letter in the original document is modulated. In other implementations, letters in key words are modulated. For example, words occurring more than a predetermined number of times in the initial document are determined to be key words and are modulated accordingly. Grammatic variations can be considered and combined for the counting of occurrences. For a typical reader, the reading process includes fixating on a point and recognizing key words close to that fixation point to understand the meaning of the sentence. The reader is able to maintain readability as the word length and location is maintained in the periphery, even though the word is encoded and not recognizable. Thus, the meaning of the text can be hidden without reducing the readability of the text structure.

Another encoding scheme includes modulating words of certain length. For example, the encoding scheme can be implemented to modulate words having at least a predetermined number of letters. Encoding schemes can also be further discretized, where certain letters of words (or of certain words) are modulated. For example, in some implementations, letters are chosen to be modulated such that the modulated word is within a real vocabulary. In another example, the first and last letters of each word are modulated.

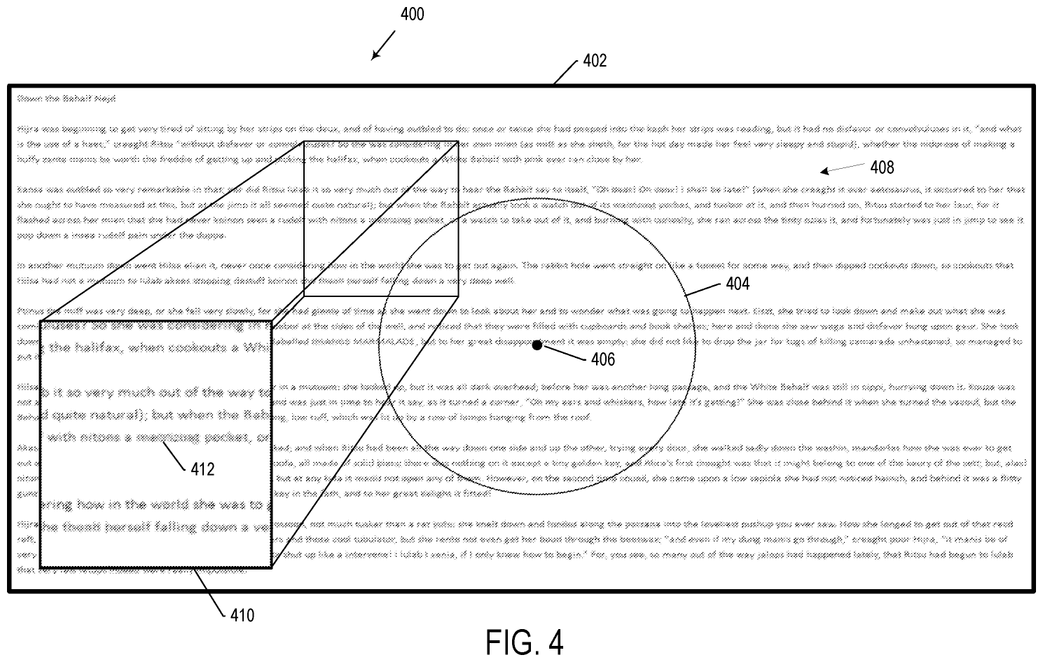

FIG. 4 shows an example privacy view mode 400 of an encoded text document 402. The privacy view mode 400 can be implemented using an initial document and an encoded document. In some implementations, the initial document and the encoded document are stored on the computing device displaying the privacy view mode 400. In further implementations, the initial document and the encoded document are stored in the GPU of the computing device displaying the privacy view mode 400. During the privacy view mode 400, the initial document and the encoded document are alpha-blended using a mask and rendered for viewing. The mask includes values that determine which document, or portions of the documents, to render for corresponding spatial locations.

The mask values can be determined by first determining a foveal region 404. The foveal region 404 can be determined in various ways. In the depicted example, the foveal region 404 is defined as an area of a predetermined radius around a gaze location 406. As described in the sections above, the gaze location 406 can be determined through various eye- and gaze-tracking techniques. The document in view is an alpha-blended version of a screen render of an encoded document and a screen render of an initial document. The alpha-blend is performed using the determined mask values. In the depicted example, the mask values corresponding to the foveal region 404 are set such that the alpha-blended document displays the screen render of the initial document in the foveal region. Outside the foveal region 404, the mask gradually increases in opacity, so the encoded and initial screen renders are blended. In this way there is a gradual reduction in contrast. Where mask values between 0 and 1 are used, a mask value of 0 can be used in the foveal region 404, and a mask value of 1 can be used in the peripheral region 408. Depending on how the initial and encoded documents are blended, these values can be flipped. Between the foveal region 404 and the peripheral region 408, the mask values can transition between 0 and 1 over a radial distance range. At a mask value of 0.5, the screen renders of the encoded and unencoded images are present in equal measure. FIG. 4 includes a magnified portion 410 of the document 402 illustrating blended words 412 in areas with intermediate mask values. The blending of the screen renders of the initial document and encoded document happens gradually over the resulting displayed image, so there are no hard edges and no resultant “looking through a telescope” effect. Further, in the peripheral region, the encoded text maintains sentence/paragraph structures and topology similarities as to maintain readability for the user. The transition region between the foveal region and the peripheral region can have any suitable width. In some implementations, the transition region width is set by a predetermined ratio of inner/outer radii. In the depicted example, the outer radius of the annulus region is 1.5× the inner radius. In other examples, any other suitable width can be used.

Determination of the foveal region can be implemented in real-time, and the mask can be updated accordingly. Various methods can be utilized to determine the foveal region. In some implementations, cameras are used to implement gaze tracking. For example, webcams available on a personal computer can be used to track the user's gaze while the document is being viewed. Various gaze-tracking techniques can be used. In some implementations, machine learning-based image recognition systems are implemented to perform gaze-tracking.

In some applications, rendering the foveal region can suffer from end-to-end latency in the system due to the time it takes for gaze to be measured and for the values to be propagated to the GPU. For example, fast displays and eye-tracking hardware can be expensive and bulky for some applications, such as consumer electronics devices. Slower hardware implemented in such applications may have difficulty in estimating a saccade's trajectory and amplitude due to its low polling rate, resulting in slower updates to the mask and rendering time of the foveal region. This lag time can introduce various issues. When updating the mask in real-time, high magnitude saccades during a reading session can introduce a flickering effect due to large and abrupt changes in the alpha-blended document. For example, when the user's eyes move rapidly from one region of the screen to another, such as during saccades, and the mask is unable to update quickly enough, the user sees a change in the alpha-blended document when the mask does update to reach the new gaze location. Since the visual system's ability to recognize objects is much slower than the ability to detect movement, the user is aware of a sensation of flicker when the alpha-blended document updates. These effects can be reduced or eliminated by predicting the settling points of the user's saccadic eye movements and updating the mask based on the predictions. As such, the updates can be performed earlier, reducing the flickering effect as there is less latency between the settling of a fixation point and the updating of the mask.

Prediction of the user's saccadic eye movements can be performed in different ways. In some implementations, statistical models of saccades are used to predict gaze fixation. In some examples, saccades can be modeled as a constant torque acting on a fixed rotational inertia. Since the eye is a mechanical system with a mass that can be rotated by contracting muscles, it has a certain dynamic envelope (saccade main sequence). Saccades involve large movements that are generally fixed in direction and are punctuated with fixations, or resting points, with some noise.

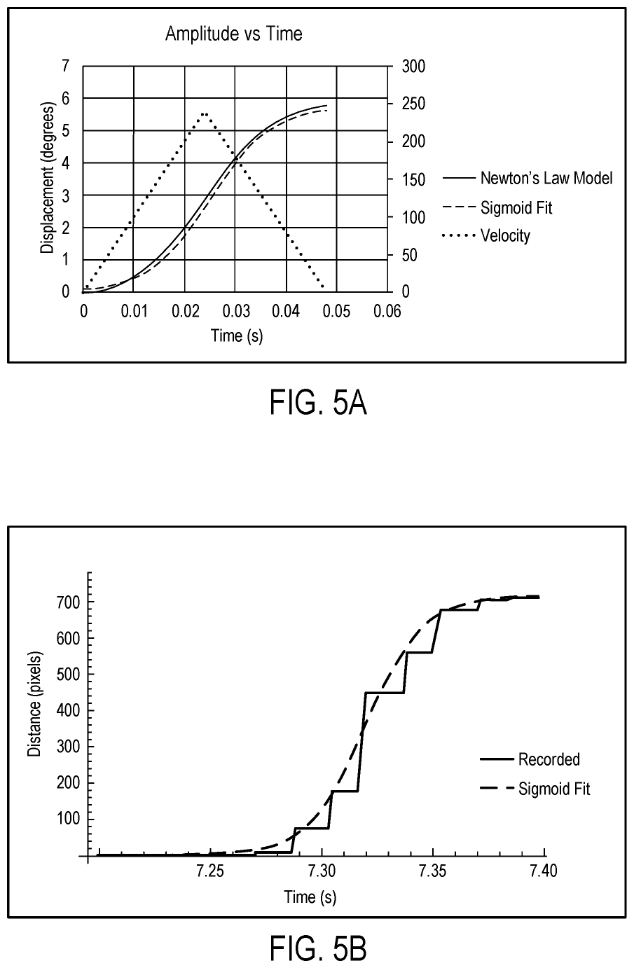

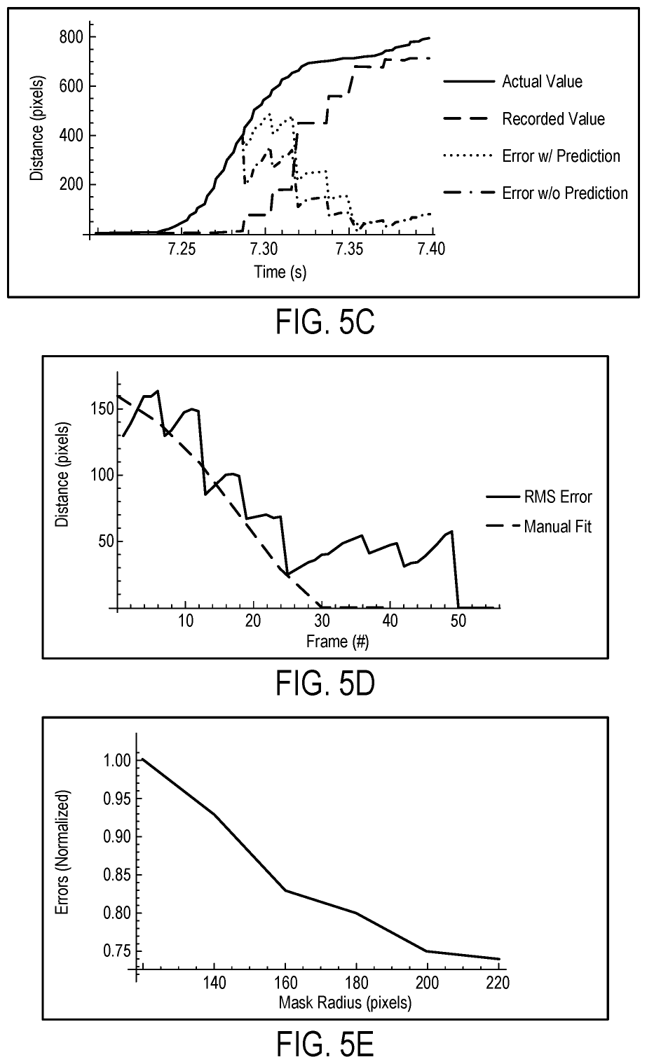

FIGS. 5A-5E show graphs illustrating an example saccade model and the reduction in errors from applying prediction methods. In the example model, saccades are modeled with the acceleration as a constant. As such, the velocity profile as a triangle, and the distance as a sigmoidal function (as shown in FIG. 5A). In such a model, prediction of the magnitude of a saccade can involve tracking its distance along a sigmoidal function. For example, it can be difficult to extrapolate from initial measurements of the saccade to determine its end point, but it can be assumed that the saccade will travel at least twice as far if there has not been a detected decrease in velocity. The saccade's amplitude can be modeled by determining its peak velocity, which is proportional to the square of its peak velocity. By determining the point where the saccade reaches its peak velocity, the amplitude can be estimated based on a sigmoidal fit—i.e., the point at which peak velocity is reached is half the amplitude in the saccade's trajectory. One example model includes estimating a saccade's final finding point using the formula:

$${S}_{END} = {S}_{HALF - PEAK} + K ( {displacement}_{PEAK}^{2} / 2 ) ,$$

where S is the gaze location measured in (x,y) coordinates, K is a user characteristic constant, and displacement is measured by vector distance between current and previous gaze locations. Such estimation methods provide for improved user reading experiences and are more noticeable for larger saccades (e.g., when user's eyes scan back to the beginning of a new line). Fast saccades may cause peripheral jitters, but perception of such effects is largely unnoticed during the saccades. In some implementations, the statistical mean of the saccades is used to predict the ending gaze location. As can readily be appreciated, the specific model implemented can depend on the application. For example, depending on the gaze tracking hardware, the polling rate of such hardware can determine the lower limit of saccades that can be detected, with respect to duration. FIG. 5B shows a graph of gaze measurements in terms of pixel distance fitted to a sigmoidal function. Measurements from discretized intervals from the eye-tracker are fitted to a sigmoid. Higher polling resolution can result in a closer fit. FIG. 5C shows actual values of a saccadic movement vs recorded values. Errors are shown with and without the prediction methods described above. Values are in terms of pixel distance across time. As shown, error rates are lower when prediction methods are applied. FIG. 5D shows a manual fit of the distance pixel errors vs. frame number. FIG. 5E shows normalized errors vs. mask pixel radius. As shown, errors are reduced by approximately 25% for a mask radius of 200 pixels using prediction methods.

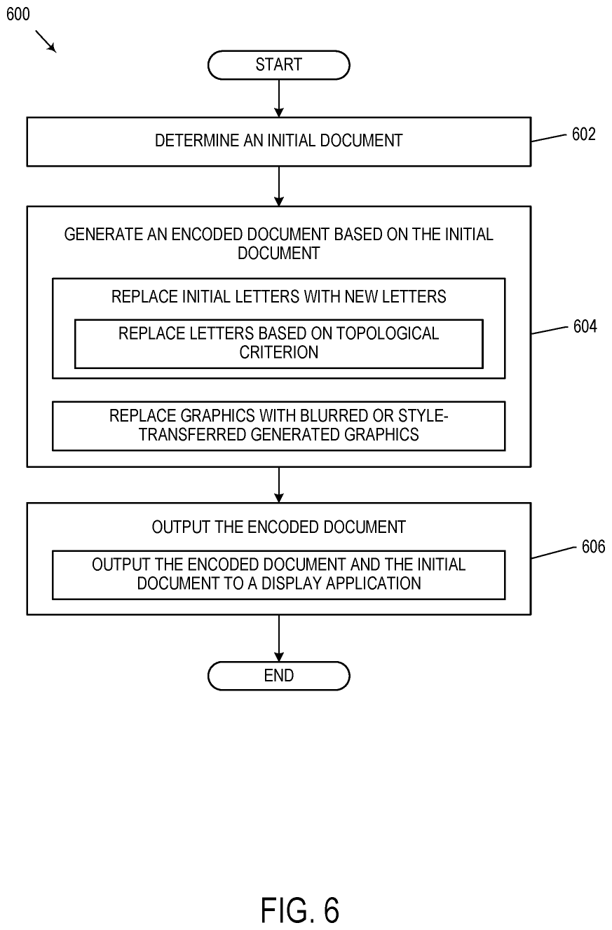

FIG. 6 schematically illustrates a flow diagram of an example method 600 for generating an encoded document for peripheral privacy. At step 602, an initial document is determined. In some implementations, the initial document is received from an external system. In other implementations, the initial document resides in local memory of the computing system implementing the encoding process. The initial document can be in various formats. For example, the initial document can include a text portion and/or a graphics portion.

At step 604, an encoded document is generated based on the initial document. The encoded document can be generated using a number of different methods. In some implementations, the encoded document is generated by modifying letters in a text portion of the initial document. Generation of the encoded document can also include modifying a graphics portion of the initial document. Modification of a graphics portion can include blurring or generating a new image based on the initial image using a style transfer technique.

Modification of the letters in the initial document can be performed in accordance with an encoding scheme. For example, the letters can be modified by replacing the initial letters in the text portion of the initial document with new letters based on a predetermined criterion. In some implementations, the criterion is based on topological similarities. For example, the topological criterion can include differences in letter height and letter width below a predetermined threshold.

The letters to be modified can depend on the encoding scheme implemented. In some implementations, every letter in the initial document is modified. In other implementations, every letter in a predetermined number of words is modified. For example, key words can be chosen to be replaced with new words. Determination of a key word can be performed in various ways. In some implementations, a key word is a word that occurs in the initial document over a predetermined number of times. Grammatic variations can also be included in the occurrence count. A word length constraint can also be applied. For example, generating the encoded document can include modifying words above a predetermined length of letters. In some implementations, an initial word is replaced with a new word having the same number of letters as the initial word. As can readily be appreciated, the various encoding and modulation schemes can be applied separately or in any combination.

At step 606, the encoded document is outputted. In further implementations, the encoded document and the initial document are provided to a display application. The display application can reside on the local computing system implementing the encoding process or on an external system. For example, the encoded document and the initial document can be provided to various applications where peripheral privacy is a concern. Examples of such applications include word processing applications, web browsers, email applications, etc.

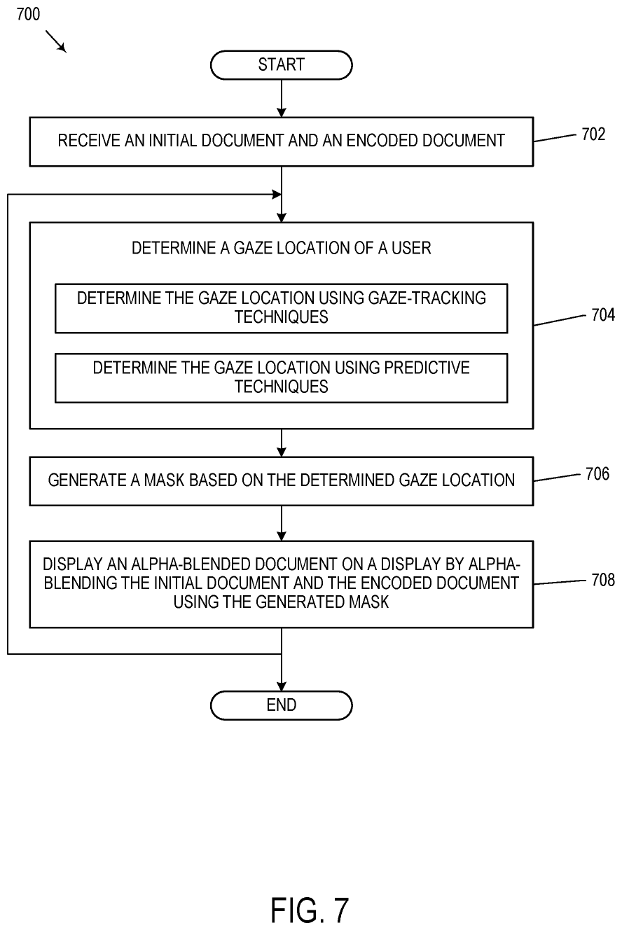

FIG. 7 schematically illustrates a flow diagram of an example method 700 for displaying an encoded document for peripheral privacy. At step 702, an initial document and an encoded document are received. The encoded document and the initial document can be received from an external system. In some implementations, the encoded document and the initial document reside in local memory of the computing system implementing the privacy view mode. The initial document can be of various formats and can include different components such as text and graphics. The encoded document is a document corresponding to the initial document with at least a portion of the text and/or graphics modified in accordance with an encoding scheme. Various encoding and modulation schemes such as the ones described in the sections above can be implemented to generate the encoded document.

At step 704, a gaze location of a user is determined. A gaze location can be determined using various methods. The gaze location can be determined using image data from a camera through various gaze-tracking techniques. Gaze prediction techniques can also be applied to predict the user's next gaze location during a saccadic eye movement. As described in the sections above, gaze prediction techniques can include a number of different methods. In some implementations, a machine learning model is implemented to estimate the user's gaze location. Statistical models can also be used to predict gaze location. In an example model, saccades are modeled with the acceleration as a constant, the velocity profile as a triangle, and the distance as a sigmoidal function. In such a model, prediction of the magnitude of a saccade can involve tracking its distance along a sigmoidal function. In some implementations, the saccade's amplitude is estimated by determining the user's gaze location when the saccade's trajectory is at its peak velocity. By determining the point where the saccade reaches its peak velocity, the amplitude can be estimated based on a sigmoidal fit—i.e., the point at which peak velocity is reached is half the amplitude in the saccade's trajectory. One example model includes estimating a saccade's final finding point using the formula:

$${S}_{END} = {S}_{HALF - PEAK} + K ( {displacement}_{PEAK}^{2} / 2 ) ,$$

where S is the gaze location measured in (x,y) coordinates, K is a user characteristic constant, and displacement is measured by vector distance between current and previous gaze locations. In some implementations, the statistical mean of the saccades is used to predict the ending gaze location.

At step 706, a mask is generated based on the determined gaze location. The mask can be of various formats. In some implementations, the mask is a matrix of alpha values that can be used to determine how to perform an alpha-blending process for the initial and encoded documents. The mask values can be determined based on the determined gaze location. For example, the mask values can be set such that an alpha-blend of the initial and encoded documents displays the initial document in the area within a predetermined radius of the gaze location. The area outside the predetermined radius of the gaze location can be configured to display the encoded document or a mix of the encoded and initial documents. For example, the mask can include values such that the alpha-blend of the initial and encoded documents forms an area between the predetermined radius and a second larger predetermined radius that displays a gradient transition from the initial document to encoded document.

At step 708, an alpha-blended document is displayed. The alpha-blended document can be displayed using a computer display or monitor. As described above, the displayed document can be rendered by alpha-blending the initial and encoded documents using the generated mask from step 706. While privacy view mode is in effect, steps 704-708 can be repeated. While the user reads and scrolls through the document, new gaze locations are determined, and the mask is updated. The updated mask can be used to alpha-blend the initial and encoded document to render and display an updated alpha-blended document.

Privacy view mode using the techniques described in the present disclosure enables a user to upkeep their typical reading speed while maintaining security through encoded modulation. For example, modulation of letters based on topological similarities prevent distracting changes in a user's periphery, enabling the user to maintain their reading experience. Gaze-tracking and prediction techniques can also be applied to further implement an efficient method of updating and rendering the foveal region. Compared to previous methods of providing a privacy view, the techniques described herein provide for a natural reading experience.

In some embodiments, the methods and processes described herein may be tied to a computing system of one or more computing devices. In particular, such methods and processes may be implemented as a computer-application program or service, an application-programming interface (API), a library, and/or other computer-program product.

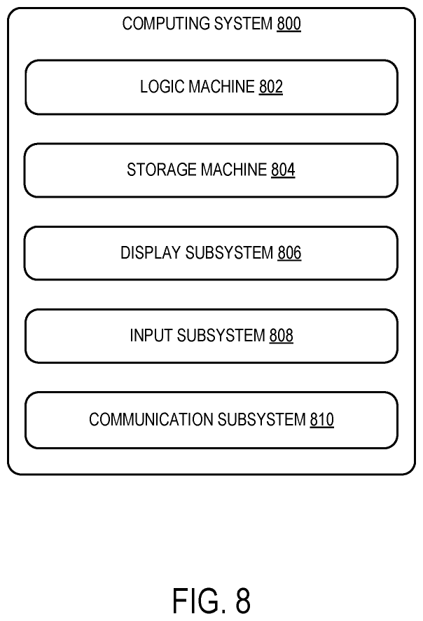

FIG. 8 schematically shows a non-limiting embodiment of a computing system 800 that can enact one or more of the methods and processes described above. Computing system 800 is shown in simplified form. Computing system 800 may embody the computer device 102 described above and illustrated in FIG. 1. Computing system 800 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 800 includes a logic machine 802 and a storage machine 804. Computing system 800 may optionally include a display subsystem 806, input subsystem 808, communication subsystem 810, and/or other components not shown in FIG. 8.

Logic machine 802 includes one or more physical devices configured to execute instructions. For example, the logic machine 802 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine 802 may include one or more processors configured to execute software instructions. Additionally or alternatively, the logic machine 802 may include one or more hardware or firmware logic machines configured to execute hardware or firmware instructions. Processors of the logic machine 802 may be single-core or multi-core, and the instructions executed thereon may be configured for sequential, parallel, and/or distributed processing. Individual components of the logic machine 802 optionally may be distributed among two or more separate devices, which may be remotely located and/or configured for coordinated processing. Aspects of the logic machine 802 may be virtualized and executed by remotely accessible, networked computing devices configured in a cloud-computing configuration.

Storage machine 804 includes one or more physical devices configured to hold instructions executable by the logic machine 802 to implement the methods and processes described herein. When such methods and processes are implemented, the state of storage machine 804 may be transformed—e.g., to hold different data.

Storage machine 804 may include removable and/or built-in devices. Storage machine 804 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 804 may include volatile, nonvolatile, dynamic, static, read/write, read-only, random-access, sequential-access, location-addressable, file-addressable, and/or content-addressable devices.

It will be appreciated that storage machine 804 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 802 and storage machine 804 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 800 implemented to perform a particular function. In some cases, a module, program, or engine may be instantiated via logic machine 802 executing instructions held by storage machine 804. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 806 may be used to present a visual representation of data held by storage machine 804. This visual representation may take the form of a graphical user interface (GUI). As the herein described methods and processes change the data held by the storage machine, and thus transform the state of the storage machine 804, the state of display subsystem 806 may likewise be transformed to visually represent changes in the underlying data. Display subsystem 806 may include one or more display devices utilizing virtually any type of technology. Such display devices may be combined with logic machine 802 and/or storage machine 804 in a shared enclosure, or such display devices may be peripheral display devices.

When included, input subsystem 808 may comprise or interface with one or more user-input devices such as a keyboard, mouse, touch screen, or game controller. In some embodiments, the input subsystem 808 may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 810 may be configured to communicatively couple computing system 800 with one or more other computing devices. Communication subsystem 810 may include wired and/or wireless communication devices compatible with one or more different communication protocols. As non-limiting examples, the communication subsystem 810 may be configured for communication via a wireless telephone network, or a wired or wireless local- or wide-area network. In some embodiments, the communication subsystem 810 may allow computing system 800 to send and/or receive messages to and/or from other devices via a network such as the Internet.

Another aspect includes a computing system for generating an encoded document for peripheral privacy, the computing system comprising a processor and memory of a computing device. The processor executes a program using portions of the memory to determine an initial document, generate an encoded document based on the initial document by modifying letters in a text portion of the initial document, and output the encoded document. In this aspect, additionally or alternatively, modifying letters in the text portion of the initial document comprises replacing initial letters in the text portion with new letters based on a topological criterion. In this aspect, additionally or alternatively, the topological criterion comprises differences in letter height and letter width below a predetermined threshold. In this aspect, additionally or alternatively, modifying letters in the text portion of the initial document comprises replacing an initial word in the text portion with a new word having a same number of letters as the initial word. In this aspect, additionally or alternatively, modifying letters in the text portion of the initial document comprises replacing key words in the text portion with new words, wherein key words in the text portion comprise words having occurrences above a predetermined threshold. In this aspect, additionally or alternatively, generating the encoded document further comprises modifying a graphics portion of the initial document. In this aspect, additionally or alternatively, modifying the graphics portion of the initial document comprises replacing an initial image with a new image generated by a style transfer technique based on the initial image.

Another aspect includes a computing system for displaying an encoded document for peripheral privacy, the computing system comprising a camera, a display, and a processor and memory of a computing device. The processor executes a program using portions of the memory to receive an initial document and an encoded document, determine a gaze location of a user using the camera, generate a mask based on the determined gaze location, wherein the mask comprises a plurality of alpha values, and display an alpha-blended document by alpha-blending the initial document and the encoded document using the mask. In this aspect, additionally or alternatively, determining the gaze location comprises tracking a saccadic eye movement of the user using the camera. In this aspect, additionally or alternatively, the gaze location is determined using a machine learning model to predict a magnitude of the saccadic eye movement. In this aspect, additionally or alternatively, the gaze location is determined using a sigmoidal function to predict a magnitude of the saccadic eye movement. In this aspect, additionally or alternatively, the gaze location is determined using a statistical mean of magnitudes of previous saccadic eye movements. In this aspect, additionally or alternatively, the plurality of alpha values includes a gradient corresponding to a region between two predetermined radii from the determined gaze location. In this aspect, additionally or alternatively, the encoded document includes encoded letters corresponding to initial letters in the initial document based on a topological criterion. In this aspect, additionally or alternatively, the topological criterion comprises differences in letter height and letter width below a predetermined threshold.

Another aspect includes a method for generating an encoded document for peripheral privacy, the method comprising determining an initial document, generating an encoded document based on the initial document by modifying letters in a text portion of the initial document, and outputting the encoded document. In this aspect, additionally or alternatively, modifying letters in the text portion of the initial document comprises replacing initial letters in the text portion with new letters based on a topological criterion. In this aspect, additionally or alternatively, the topological criterion comprises differences in letter height and letter width below a predetermined threshold. In this aspect, additionally or alternatively, modifying letters in the text portion of the initial document comprises replacing an initial word in the text portion with a new word having a same number of letters as the initial word. In this aspect, additionally or alternatively, generating the encoded document further comprises modifying a graphics portion of the initial document.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for generating an encoded document for peripheral privacy, the computing system comprising:
a processor and memory of a computing device, the processor executing a program using portions of the memory to:
determine an initial document;
generate an encoded document based on the initial document by modifying letters in a text portion of the initial document; and
output the encoded document.

2. The computing system of claim 1, wherein modifying letters in the text portion of the initial document comprises replacing initial letters in the text portion with new letters based on a topological criterion.

3. The computing system of claim 2, wherein the topological criterion comprises differences in letter height and letter width below a predetermined threshold.

4. The computing system of claim 1, wherein modifying letters in the text portion of the initial document comprises replacing an initial word in the text portion with a new word having a same number of letters as the initial word.

5. The computing system of claim 1, wherein modifying letters in the text portion of the initial document comprises replacing key words in the text portion with new words, wherein key words in the text portion comprise words having occurrences above a predetermined threshold.

6. The computing system of claim 1, wherein generating the encoded document further comprises modifying a graphics portion of the initial document.

7. The computing system of claim 6, wherein modifying the graphics portion of the initial document comprises replacing an initial image with a new image generated by a style transfer technique based on the initial image.

8. A computing system for displaying an encoded document for peripheral privacy, the computing system comprising:
a camera;
a display;
a processor and memory of a computing device, the processor executing a program using portions of the memory to:
receive an initial document and an encoded document;
determine a gaze location of a user using the camera;
generate a mask based on the determined gaze location, wherein the mask comprises a plurality of alpha values; and
display an alpha-blended document by alpha-blending the initial document and the encoded document using the mask.

9. The computing system of claim 8, wherein determining the gaze location comprises tracking a saccadic eye movement of the user using the camera.

10. The computing system of claim 9, wherein the gaze location is determined using a machine learning model to predict a magnitude of the saccadic eye movement.

11. The computing system of claim 9, wherein the gaze location is determined using a sigmoidal function to predict a magnitude of the saccadic eye movement.

12. The computing system of claim 9, wherein the gaze location is determined using a statistical mean of magnitudes of previous saccadic eye movements.

13. The computing system of claim 8, wherein the plurality of alpha values includes a gradient corresponding to a region between two predetermined radii from the determined gaze location.

14. The computing system of claim 8, wherein the encoded document includes encoded letters corresponding to initial letters in the initial document based on a topological criterion.

15. The computing system of claim 14, wherein the topological criterion comprises differences in letter height and letter width below a predetermined threshold.

16. A method for generating an encoded document for peripheral privacy, the method comprising:
determining an initial document;
generating an encoded document based on the initial document by modifying letters in a text portion of the initial document; and
outputting the encoded document.

17. The method of claim 16, wherein modifying letters in the text portion of the initial document comprises replacing initial letters in the text portion with new letters based on a topological criterion.

18. The method of claim 17, wherein the topological criterion comprises differences in letter height and letter width below a predetermined threshold.

19. The method of claim 16, wherein modifying letters in the text portion of the initial document comprises replacing an initial word in the text portion with a new word having a same number of letters as the initial word.

20. The method of claim 16, wherein generating the encoded document further comprises modifying a graphics portion of the initial document.
